(19) United States
(12) Patent Application Publication
(10) Pub. No.: US 2022/0168708 A1
(43) Pub. Date: Jun. 2, 2022

(54) TITANIUM OXIDE FINE PARTICLE MIXTURE, DISPERSION LIQUID THEREOF, PHOTOCATALYST THIN FILM, MEMBER HAVING PHOTOCATALYST THIN FILM ON SURFACE, AND METHOD FOR PRODUCING TITANIUM OXIDE FINE PARTICLE DISPERSION LIQUID

(71) Applicant: Shin-Etsu Chemical Co., Ltd., Tokyo (JP)

(72) Inventors: Manabu FURUDATE, Kamisu-shi (JP); Tomohiro INOUE, Kamisu-shi (JP)

(73) Assignee: Shin-Etsu Chemical Co., Ltd., Tokyo (JP)

(21) Appl. No.: 17/432,856

(22) PCT Filed: Feb. 21, 2020
(86) PCT No.: PCT/JP2020/007165

§ 371 Date: Aug. 20, 2021

(30) Foreign Application Priority Data
Mar. 4, 2019 (JP) 2019-038447

(51) Int. Cl. B01J 21/06; B01J 35/00; B01J 37/04

(52) U.S. Cl. CPC B01J 21/063; B01J 37/04; B01J 35/004

(57) ABSTRACT

Provided is a titanium oxide fine particle mixture having a high photocatalytic activity, especially a high photocatalytic activity in the visible light region. The titanium oxide fine particle mixture contains:
first titanium oxide fine particles; and
second titanium oxide fine particles, wherein
the second titanium oxide fine particles are titanium oxide fine particles with at least an iron component and a silicon component solid-dissolved therein, and
the first titanium oxide fine particles are titanium oxide fine particles that may have a component(s) other than an iron component and a silicon component solid-dissolved therein.

### TECHNICAL FIELD

The present invention relates to a titanium oxide fine particle mixture, a dispersion liquid thereof, a photocatalyst thin film formed using such dispersion liquid, a member having the photocatalyst thin film on surface, and a method for producing a titanium oxide fine particle dispersion liquid; more specifically relates to, for example, a visible light responsive photocatalyst titanium oxide fine particle mixture capable of expressing a photocatalytic activity even under only a visible light (wavelength 400 to 800 nm), and being used to easily produce a photocatalyst thin film having a high transparency.

### BACKGROUND ART

Photocatalysts are often used for the purposes of, for example, cleaning, deodorizing and bringing about an antibacterial effect on the surface of a base material. A photocatalytic reaction refers to a reaction caused by excited electrons and positive holes that have occurred as a result of having a photocatalyst absorb a light. It is considered that the decomposition of an organic substance by a photocatalyst is mainly triggered by the following mechanisms [1] or [2].

[1] The excited electrons and positive holes that have been generated undergo a redox reaction with the oxygen and water that have adsorbed to the surface of the photocatalyst, so that one or more active species that have occurred due to the redox reaction shall decompose the organic substance.

[2] The positive holes that have been generated decompose the organic substance that have adsorbed to the surface of the photocatalyst by directly oxidizing the same.

Recently, as for the application of the above photocatalytic action, studies are being conducted on uses not only outdoors where ultraviolet light is available, but also indoors where a light source(s) mostly composed of lights in the visible region (wavelength 400 to 800 nm), such as a fluorescent light, are used for illumination. For example, as a visible light responsive photocatalyst, there has been developed a tungsten oxide photocatalyst body (JP-A-2009-148700: Patent document 1); since tungsten is a scarce element, it is desired that titanium as a general element be utilized to enhance the visible light activity of a photocatalyst.

As a method for enhancing the visible light activity of a photocatalyst utilizing titanium oxide, there are known, for example, a method of having iron and/or copper supported on the surfaces of titanium oxide fine particles and titanium oxide fine particles doped with a metal (e.g. JP-A-2012-210632: Patent document 2, JP-A-2010-104913: Patent document 3, JP-A-2011-240247: Patent document 4, JP-A-Hei-7-303835: Patent document 5); a method where there are at first separately prepared titanium oxide fine particles with tin and a visible light activity-enhancing transition metal solid-dissolved (doped) therein and titanium oxide fine particles with copper solid-dissolved therein, followed by mixing them before use (WO2014/045861: Patent document 6); and a method where there are at first separately prepared titanium oxide fine particles with tin and a visible light responsiveness-enhancing transition metal solid-dissolved therein and titanium oxide fine particles with an iron group element solid-dissolved therein, followed by mixing them before use (WO2016/152487: Patent document 7).

As a result of using a photocatalyst film formed with a visible light-responsive photocatalyst titanium oxide fine particle dispersion liquid that is obtained by mixing the separately prepared titanium oxide fine particles with tin and a visible light activity-enhancing transition metal solid-dissolved therein and the separately prepared titanium oxide fine particles with an iron group element solid-dissolved therein as is the case with the latter method (Patent document 7), while a high decomposition activity can be achieved even when a decomposition substrate is at a low concentration, which has been difficult under a condition where only lights in the visible region are available, further enhancement in visible light activity are required to actually feel a satisfactory effect(s) under a real environment.

### PRIOR ART DOCUMENTS

### Patent Documents

Patent document 1: JP-A-2009-148700
Patent document 2: JP-A-2012-210632
Patent document 3: JP-A-2010-104913
Patent document 4: JP-A-2011-240247
Patent document 5: JP-A-Hei-7-303835
Patent document 6: WO2014/045861
Patent document 7: WO2016/152487

### SUMMARY OF THE INVENTION

### Problems to be Solved by the Invention

Thus, it is an object of the present invention to provide a titanium oxide fine particle mixture having a photocatalytic activity higher than before, particularly a visible light activity higher than before; a dispersion liquid thereof; a photocatalyst thin film formed using such dispersion liquid; a member having such photocatalyst thin film on surface; and a method for producing a titanium oxide fine particle dispersion liquid.

### Means to Solve the Problems

In order to achieve the above object, the inventors of the present invention completed the invention as follows. That is, as a result of more precisely studying, for example, metal elements to be solid-dissolved in titanium oxide fine particles as well as combinations thereof, combinations of titanium oxides with metal elements solid-dissolved therein, and mixing ratios, the inventors found that a photocatalytic activity, particularly a visible light activity could be dramatically enhanced by mixing titanium oxide fine particles with an iron component and a silicon component solid-dissolved therein into a photocatalyst (particularly, titanium oxide fine particles with a particular metal solid-dissolved therein).

Therefore, the present invention is to provide the following titanium oxide fine particle mixture; a dispersion liquid thereof; a photocatalyst thin film formed using such dispersion liquid; a member having such photocatalyst thin film on surface; and a method for producing a titanium oxide fine particle dispersion liquid.

[1]

A titanium oxide fine particle mixture comprising:
first titanium oxide fine particles; and
second titanium oxide fine particles, wherein

the second titanium oxide fine particles are titanium oxide fine particles with at least an iron component and a silicon component solid-dissolved therein, and

the first titanium oxide fine particles are titanium oxide fine particles that may have a component(s) other than an iron component and a silicon component solid-dissolved therein.

[2]

The titanium oxide fine particle mixture according to [1], wherein a mixing ratio between the first titanium oxide fine particles and the second titanium oxide fine particles is 99 to 0.01 in terms of a mass ratio [(first titanium oxide fine particles)/(second titanium oxide fine particles)].

[3]

The titanium oxide fine particle mixture according to [1] or [2], wherein the first titanium oxide fine particles are titanium oxide fine particles with a tin component and a visible light responsiveness-enhancing transition metal component solid-dissolved therein.

[4]

The titanium oxide fine particle mixture according to [3], wherein the tin component is contained and solid-dissolved in the first titanium oxide fine particles by an amount of 1 to 1,000 in terms of a molar ratio to titanium (Ti/Sn).

[5]

The titanium oxide fine particle mixture according to [3] or [4], wherein the transition metal component solid-dissolved in the first titanium oxide fine particles is at least one selected from vanadium, chromium, manganese, niobium, molybdenum, rhodium, tungsten and cerium.

[6]

The titanium oxide fine particle mixture according to [5], wherein the transition metal component solid-dissolved in the first titanium oxide fine particles is at least one selected from molybdenum, tungsten and vanadium.

[7]

The titanium oxide fine particle mixture according to [6], wherein the molybdenum, tungsten and vanadium components are each contained and solid-dissolved in the first titanium oxide fine particles by an amount of 1 to 10,000 in terms of a molar ratio to titanium (Ti/Mo, Ti/W or Ti/V).

[8]

The titanium oxide fine particle mixture according to any one of [1] to [7], wherein the iron and silicon components are each contained and solid-dissolved in the second titanium oxide fine particles by an amount of 1 to 1,000 in terms of a molar ratio to titanium (Ti/Fe or Ti/Si).

[9]

The titanium oxide fine particle mixture according to any one of [1] to [8], wherein the second titanium oxide fine particles further have at least one component selected from molybdenum, tungsten and vanadium solid-dissolved therein.

[10]

A titanium oxide fine particle dispersion liquid wherein the titanium oxide fine particle mixture according to any one of [1] to [9] is dispersed in an aqueous dispersion medium.

[11]

The titanium oxide fine particle dispersion liquid according to [10], wherein the titanium oxide fine particle dispersion liquid further comprises a binder.

[12]

The titanium oxide fine particle dispersion liquid according to [11], wherein the binder is a silicon compound-based binder.

[13]

A photocatalyst thin film comprising the titanium oxide fine particle mixture according to any one of [1] to [9].

[14]

The photocatalyst thin film according to [13], wherein the photocatalyst thin film further comprises a binder.

[15]

A member wherein the photocatalyst thin film according to [13] or [14] is formed on a surface of a base material.

[16]

A method for producing a titanium oxide fine particle dispersion liquid, comprising:
(1) a step of producing a tin component and transition metal component-containing peroxotitanic acid solution from a raw material titanium compound, tin compound, transition metal compound, basic substance, hydrogen peroxide and aqueous dispersion medium;
(2) a step of obtaining a tin component and transition metal component-containing titanium oxide fine particle dispersion liquid by heating the tin component and transition metal component-containing peroxotitanic acid solution produced in the step (1) at 80 to 250° C. under a controlled pressure;
(3) a step of producing an iron component and silicon component-containing peroxotitanic acid solution from a raw material titanium compound, iron compound, silicon compound, basic substance, hydrogen peroxide and aqueous dispersion medium;
(4) a step of obtaining an iron component and silicon component-containing titanium oxide fine particle dispersion liquid by heating the iron component and silicon component-containing peroxotitanic acid solution produced in the step (3) at 80 to 250° C. under a controlled pressure; and
(5) a step of mixing the two kinds of titanium oxide fine particle dispersion liquids produced in the steps (2) and (4).

### Effects of the Invention

The titanium oxide fine particle mixture of the present invention has a photocatalytic activity, particularly a high photocatalytic activity even under only a visible light (wavelength 400 to 800 nm). Further, a photocatalyst thin film having a high transparency can be easily formed from the dispersion liquid of such titanium oxide fine particle mixture. Thus, the titanium oxide fine particle mixture of the present invention is suitable for use in members that are used indoors where a light source(s) mostly composed of visible lights, such as a fluorescent light and a white LED, are used for illumination.

### MODE FOR CARRYING OUT THE INVENTION

The present invention is described in detail hereunder.

### <Titanium Oxide Fine Particle Mixture>

A titanium oxide fine particle mixture of the present invention is a titanium oxide fine particle mixture containing first titanium oxide fine particles and second titanium oxide fine particles as titanium oxide fine particles mutually having different compositions. Particularly, it is desired that this mixture be used as a dispersion liquid.

### <Titanium Oxide Fine Particle Dispersion Liquid>

A titanium oxide fine particle dispersion liquid of the present invention is such that dispersed in an aqueous dispersion medium are the first titanium oxide fine particles and the second titanium oxide fine particles as titanium oxide fine particles mutually having different compositions. The first titanium oxide fine particles are titanium oxide fine particles that may have a component(s) other than an iron component and a silicon component solid-dissolved therein; preferred are titanium oxide fine particles with a tin component and a visible light responsiveness-enhancing transition metal component other than iron solid-dissolved therein. The second titanium oxide fine particles are titanium oxide fine particles with at least an iron component and a silicon component solid-dissolved therein.

Here, in this specification, a solid solution refers to that having a phase where atoms at lattice points in a certain crystal phase have been substituted by other atoms or where other atoms have entered lattice spacings i.e. a mixed phase regarded as one with a different substance(s) dissolved into a certain crystal phase, and being a homogeneous phase as a crystal phase. A solid solution where solvent atoms at lattice points have been substituted by solute atoms is called a substitutional solid solution, and a solid solution where solute atoms have entered lattice spacings is called an interstitial solid solution; in this specification, a solid solution refers to both of them.

In the case of the first titanium oxide fine particles of the present invention, the first titanium oxide fine particles may form a solid solution with atoms other than iron atoms and silicon atoms; particularly, the first titanium oxide fine particles may form a solid solution with tin atoms and visible light responsiveness-enhancing transition metal atoms other than iron atoms. The second titanium oxide fine particles are characterized by forming a solid solution with iron atoms and silicon atoms. The solid solution may be either substitutional or interstitial. A substitutional solid solution of titanium oxide is formed by having titanium sites of a titanium oxide crystal substituted by various metal atoms; an interstitial solid solution of titanium oxide is formed by having various metal atoms enter the lattice spacings of a titanium oxide crystal. After various metal atoms have been solid-dissolved into titanium oxide, when measuring the crystal phase by X-ray diffraction or the like, there will only be observed the peak of the crystal phase of titanium oxide, whereas there will not be observed peaks of compounds derived from various metal atoms added.

While there are no particular restrictions on a method for solid-dissolving dissimilar metals into a metal oxide crystal, there may be listed, for example, a gas phase method (e.g. CVD method, PVD method), a liquid phase method (e.g. hydrothermal method, sol-gel process) and a solid phase method (e.g. high-temperature firing).

As a crystal phase of titanium oxide fine particles, there are generally known three of them which are the rutile-type, anatase-type and brookite-type. It is preferred that the first or second titanium oxide fine particles mainly employ the rutile-type or anatase-type. Particularly, it is preferred that the first titanium oxide fine particles mainly employ the rutile-type, and that the second titanium oxide fine particles mainly employ the anatase-type. Here, the expression “mainly” refers to a condition where the titanium oxide fine particles having such particular crystal phase(s) are contained in the titanium oxide fine particles as a whole by an amount of not smaller than 50% by mass, preferably not smaller than 70% by mass, even more preferably not smaller than 90% by mass, or even 100% by mass.

Further, as a dispersion medium of the dispersion liquid, an aqueous solvent is normally used, and it is preferred that water be used. However, there may also be used a mixed solvent of water and a hydrophilic organic solvent which is to be mixed with water at any ratio. As water, preferred are purified waters such as a filtrate water, a deionized water, a distilled water and a pure water. Moreover, as the hydrophilic organic solvent, preferred are, for example, alcohols such as methanol, ethanol and isopropanol; glycols such as ethylene glycol; and glycol ethers such as ethylene glycol monomethyl ether, ethylene glycol monoethyl ether and propylene glycol-n-propyl ether. If using the mixed solvent, it is preferred that a ratio of the hydrophilic organic solvent in the mixed solvent be larger than 0% by mass, but not larger than 50% by mass; more preferably larger than 0% by mass, but not larger than 20% by mass; even more preferably larger than 0% by mass, but not larger than 10% by mass.

As the first titanium oxide fine particles, there may be employed a titanium oxide used as a photocatalyst. While the first titanium oxide fine particles may be any one of titanium oxide fine particles; titanium oxide fine particles supporting a metal component(s) such as platinum, gold, palladium, iron, copper and nickel; and titanium oxide fine particles with a metal component(s) solid-dissolved therein, preferred are titanium oxide fine particles with a component(s) other than an iron component and a silicon component solid-dissolved therein, more preferred are fine particles of titanium oxide with a tin component and a visible light responsiveness-enhancing transition metal component other than an iron component solid-dissolved therein.

As for the first titanium oxide fine particles, if solid-dissolving a tin component and a visible light responsiveness-enhancing transition metal component other than an iron component, the transition metal is an element selected from the group 3 to group 11 in the periodic table; as a visible light responsiveness-enhancing transition metal component, there may be selected from vanadium, chromium, manganese, niobium, molybdenum, rhodium, tungsten, cerium and the like, among which molybdenum, tungsten and vanadium are preferably selected.

While the tin component to be solid-dissolved in the first titanium oxide fine particles is to enhance the visible light responsiveness of a photocatalyst thin film, it will suffice if the tin component is that derived from a tin compound, examples of which include elemental tin as a metal (Sn), a tin oxide (SnO, SnO₂), a tin hydroxide, a tin chloride (SnCl₂, SnCl₄), a tin nitrate (Sn(NO₃)₂), a tin sulfate (Sn₅O₄), a tin halide (Br, I), a salt of tin-oxoacid (stannate) (Na₂SnO₃, K₂SnO₃) and a tin complex compound; there may be used one of them or a combination of two or more of them. Particularly, it is preferred that there be used a tin oxide (SnO, SnO₂), a tin chloride (SnCl₂, SnCl₄), a tin sulfate (Sn₅O₄) and a salt of tin-oxoacid (stannate) (Na₂SnO₃, K₂SnO₃).

The tin component is contained in the first titanium oxide fine particles by an amount of 1 to 1,000, preferably 5 to 500, more preferably 5 to 100, in terms of a molar ratio to titanium (Ti/Sn). This is because if the molar ratio is lower than 1, a photocatalytic effect may not be sufficiently exhibited as titanium oxide is now contained at a lower rate; and if the molar ratio is greater than 1,000, an insufficient visible light responsiveness may be observed.

The transition metal component to be solid-dissolved in the first titanium oxide fine particles may be that derived from a corresponding transition metal compound, examples of which include a metal, an oxide, a hydroxide, a chloride, a nitrate, a sulfate, a halide (Br, I), a salt of oxoacid and various complex compounds; there may be used one of them or a combination of two or more of them.

The amount of the transition metal component(s) contained in the first titanium oxide fine particles may be appropriately determined based on the type of the transition metal component; it is preferred that the amount thereof be 1 to 10,000 in terms of a molar ratio to titanium (Ti/transition metal).

When molybdenum is selected as the transition metal component to be solid-dissolved in the first titanium oxide fine particles, it will suffice if the molybdenum component is that derived from a molybdenum compound, examples of which include elemental molybdenum as a metal (Mo), a molybdenum oxide (MoO₂, MoO₃), a molybdenum hydroxide, a molybdenum chloride (MoCl₃, MoCl₅), a molybdenum nitrate, a molybdenum sulfate, a molybdenum halide (Br, I), a molybdic acid and salt of molybdenum-oxoacid (molybdate) (H₂MoO₄, Na₂MoO₄, K₂MoO₄), and a molybdenum complex compound; there may be used one of them or a combination of two or more of them. Particularly, it is preferred that there be used a molybdenum oxide (MoO₂, MoO₃), a molybdenum chloride (MoCl₃, MoCl₅) and a salt of molybdenum-oxoacid (molybdate) (H₂MoO₄, Na₂MoO₄, K₂MoO₄).

The molybdenum component is contained in the first titanium oxide fine particles by an amount of 1 to 10,000, preferably 5 to 5,000, more preferably 20 to 1,000, in terms of a molar ratio to titanium (Ti/Mo). This is because if the molar ratio is lower than 1, a photocatalytic effect may not be sufficiently exhibited as titanium oxide is now contained at a lower rate; and if the molar ratio is greater than 10,000, an insufficient visible light responsiveness may be observed.

When tungsten is selected as the transition metal component to be solid-dissolved in the first titanium oxide fine particles, it will suffice if the tungsten component is that derived from a tungsten compound, examples of which include elemental tungsten as a metal (W), a tungsten oxide (WO₃), a tungsten hydroxide, a tungsten chloride (WCl₄, WCl₆), a tungsten nitrate, a tungsten sulfate, a tungsten halide (Br, I), a tungstic acid and salt of tungsten-oxoacid (tungstate) (H₂WO₄, Na₂WO₄, K₂WO₄), and a tungsten complex compound; there may be used one of them or a combination of two or more of them. Particularly, it is preferred that there be used a tungsten oxide (WO₃), a tungsten chloride (WCl₄, WCl₆) and a salt of tungsten-oxoacid (tungstate) (Na₂WO₄, K₂WO₄).

The tungsten component is contained in the first titanium oxide fine particles by an amount of 1 to 10,000, preferably 5 to 5,000, more preferably 20 to 2,000, in terms of a molar ratio to titanium (Ti/W). This is because if the molar ratio is lower than 1, a photocatalytic effect may not be sufficiently exhibited as titanium oxide is now contained at a lower rate; and if the molar ratio is greater than 10,000, an insufficient visible light responsiveness may be observed.

When vanadium is selected as the transition metal component to be solid-dissolved in the first titanium oxide fine particles, it will suffice if the vanadium component is that derived from a vanadium compound, examples of which include elemental vanadium as a metal (V), a vanadium oxide (VO, V₂O₃, VO₂, V₂O₅), a vanadium hydroxide, a vanadium chloride (VCl₅), a vanadium oxychloride (VOCl₃), a vanadium nitrate, a vanadium sulfate, a vanadyl sulfate (VOSO₄), a vanadium halide (Br, I), a salt of vanadium-oxoacid (vanadate) (Na₃VO₄, K₃VO₄, KVO₃), and a vanadium complex compound; there may be used one of them or a combination of two or more of them. Particularly, it is preferred that there be used a vanadium oxide (V₂O₃, V₂O₅), a vanadium chloride (VCl₅), a vanadium oxychloride (VOCl₃), a vanadyl sulfate (VOSO₄), and a salt of vanadium-oxoacid (vanadate) (Na₃VO₄, K₃VO₄, KVO₃).

The vanadium component is contained in the first titanium oxide fine particles by an amount of 1 to 10,000, preferably 10 to 10,000, more preferably 100 to 10,000, in terms of a molar ratio to titanium (Ti/V). This is because if the molar ratio is lower than 1, a photocatalytic effect may not be sufficiently exhibited as titanium oxide is now contained at a lower rate; and if the molar ratio is greater than 10,000, an insufficient visible light responsiveness may be observed.

As the transition metal component(s) to be solid-dissolved in the first titanium oxide fine particles, there may also be selected multiple components from molybdenum, tungsten and vanadium. The amount of each component at that time may be selected from the above ranges. However, a molar ratio between a sum of the components and titanium [Ti/(Mo+W+V)] is not lower than 1, but lower than 10,000.

As the first titanium oxide fine particles, one kind thereof may be used, or two or more kinds thereof may be used in combination. There may be achieved an effect of enhancing a visible light activity if combining two or more kinds of the first titanium oxide fine particles having different visible light responsivenesses.

The second titanium oxide fine particles have a composition different from that of the first titanium oxide fine particles, and are characterized by having an iron component and a silicon component solid-dissolved therein.

In addition to the iron component and silicon component, molybdenum, tungsten and vanadium as transition metal components similar to those used in the first titanium oxide fine particles may be further solid-dissolved in the second titanium oxide fine particles, as components enhancing visible light responsiveness.

The iron component to be solid-dissolved in the second titanium oxide fine particles may be that derived from an iron compound, examples of which include elemental iron as a metal (Fe), an iron oxide (Fe₂O₃, Fe₃O₄), an iron hydroxide, an iron oxyhydroxide (FeO(OH)), an iron chloride (FeCl₂, FeCl₃), an iron nitrate (Fe(NO)₃), an iron sulfate (FeSO₄, Fe₂(SO₄)₃), an iron halide (Br, I) and an iron complex compound; there may be used one of them or a combination of two or more of them. Particularly, it is preferred that there be used an iron oxide (Fe₂O₃, Fe₃O₄), an iron oxyhydroxide (FeO(OH)), an iron chloride (FeCl₂, FeCl₃), an iron nitrate (Fe(NO)₃) and an iron sulfate (FeSO₄, Fe₂(SO₄)₃).

The iron component is contained in the second titanium oxide fine particles by an amount of 1 to 1,000, preferably 2 to 200, more preferably 5 to 100, in terms of a molar ratio to titanium (Ti/Fe). This is because if the molar ratio is lower than 1, a photocatalytic effect may not be sufficiently exhibited as titanium oxide is now contained at a lower rate; and if the molar ratio is greater than 1,000, an insufficient visible light responsiveness may be observed.

The silicon component to be solid-dissolved in the second titanium oxide fine particles may be that derived from a silicon compound, examples of which include elemental silicon as a metal (Si), a silicon oxide (SiO, SiO₂), a silicon alkoxide (Si(OCH₃)₄, Si(OC₂H₅)₄, Si(OCH(CH₃)₂)₄) and a silicate (sodium salt, potassium salt); there may be used one of them or a combination of two or more of them. Particularly, it is preferred that there be used a silicate (sodium silicate).

The silicon component is contained in the second titanium oxide fine particles by an amount of 1 to 1,000, preferably 2 to 200, more preferably 3 to 100, in terms of a molar ratio to titanium (Ti/Si). This is because if the molar ratio is lower than 1, a photocatalytic effect may not be sufficiently exhibited as titanium oxide is now contained at a lower rate; and if the molar ratio is greater than 1,000, an insufficient visible light responsiveness may be observed.

If a transition metal component(s) is to be solid-dissolved in the second titanium oxide fine particles, the amount of the transition metal component(s) contained may be appropriately determined based on the type of the transition metal component; it is preferred that the amount thereof be 1 to 10,000 in terms of a molar ratio to titanium (Ti/transition metal).

When molybdenum is selected as the transition metal component to be solid-dissolved in the second titanium oxide fine particles, it will suffice if the molybdenum component is that derived from a molybdenum compound similar to those in the case of the first titanium oxide fine particles.

The molybdenum component is contained in the second titanium oxide fine particles by an amount of 1 to 10,000, preferably 5 to 5,000, more preferably 20 to 1,000, in terms of a molar ratio to titanium (Ti/Mo). This is because if the molar ratio is lower than 1, a photocatalytic effect may not be sufficiently exhibited as titanium oxide is now contained at a lower rate; and if the molar ratio is greater than 10,000, an insufficient visible light responsiveness may be observed.

When tungsten is selected as the transition metal component to be solid-dissolved in the second titanium oxide fine particles, it will suffice if the tungsten component is that derived from a tungsten compound similar to those in the case of the first titanium oxide fine particles.

The tungsten component is contained in the second titanium oxide fine particles by an amount of 1 to 10,000, preferably 5 to 5,000, more preferably 20 to 1,000, in terms of a molar ratio to titanium (Ti/W). This is because if the molar ratio is lower than 1, a photocatalytic effect may not be sufficiently exhibited as titanium oxide is now contained at a lower rate; and if the molar ratio is greater than 10,000, an insufficient visible light responsiveness may be observed.

When vanadium is selected as the transition metal component to be solid-dissolved in the second titanium oxide fine particles, it will suffice if the vanadium component is that derived from a vanadium compound similar to those in the case of the first titanium oxide fine particles.

The vanadium component is contained in the second titanium oxide fine particles by an amount of 1 to 10,000, preferably 10 to 10,000, more preferably 100 to 10,000, in terms of a molar ratio to titanium (Ti/V). This is because if the molar ratio is lower than 1, a photocatalytic effect may not be sufficiently exhibited as titanium oxide is now contained at a lower rate; and if the molar ratio is greater than 10,000, an insufficient visible light responsiveness may be observed.

As the transition metal component(s) to be solid-dissolved in the second titanium oxide fine particles, there may also be selected multiple components from molybdenum, tungsten and vanadium. The amount of each component at that time may be selected from the above ranges. However, a molar ratio between a sum of the components and titanium [Ti/(Mo+W+V)] is not lower than 1, but lower than 10,000.

As the second titanium oxide fine particles, one kind thereof may be used, or two or more kinds thereof may be used in combination. There may be achieved an effect of enhancing a visible light activity if combining two or more kinds of the second titanium oxide fine particles having different visible light responsivenesses.

Here, while there are no particular restrictions if the metal(s) listed above are able to be solid-dissolved, preferable combinations of the metal components to be solid-dissolved may, for example, be Ti—Sn, Ti—Mo, Ti—W, Ti—V, Ti—Sn—Mo, Ti—Sn—W, Ti—Sn—V, Ti—Mo—W, Ti—Mo—V, Ti—W—V, Ti—Sn—Mo—W, Ti—Sn—Mo—V, Ti—Sn—W—V and Ti—Sn—Mo—W—V.

It is preferred that the first titanium oxide fine particles and the second titanium oxide fine particles in the titanium oxide fine particle mixture each have a particle diameter of 5 to 30 nm, more preferably 5 to 20 nm, the particle diameter being a 50% cumulative distribution diameter (possibly referred to as D₅₀ hereunder) on volumetric basis that is measured by a dynamic light scattering method using a laser light. This is because if D₅₀ is smaller than 5 nm, an insufficient photocatalytic activity may be observed; and if D₅₀ is greater than 30 nm, the dispersion liquid may be opaque.

Further, as for a 90% cumulative distribution diameter (possibly referred to as D₉₀ hereunder) on volumetric basis of both the first and second titanium oxide fine particles, it is preferred that such diameter be 5 to 100 nm, more preferably 5 to 80 nm. This is because if D₉₀ is smaller than 5 nm, an insufficient photocatalytic activity may be observed; and if D₉₀ is greater than 100 nm, the dispersion liquid may be opaque.

Here, as a device for measuring D₅₀ and D₉₀ of the first titanium oxide fine particles and the second titanium oxide fine particles in the titanium oxide fine particle mixture, there may be used, for example, ELSZ-2000ZS (by Otsuka Electronics Co., Ltd.), NANOTRAC UPA-EX150 (by Nikkiso Co., Ltd.) or LA-910 (by HORIBA, Ltd.).

It is preferred that a mixing ratio between the first titanium oxide fine particles and the second titanium oxide fine particles that are contained in the titanium oxide fine particle mixture be 99 to 0.01, more preferably 99 to 0.1, even more preferably 19 to 1, in terms of a mass ratio therebetween [(first titanium oxide fine particles)/(second titanium oxide fine particles)]. This is because if such mass ratio is greater than 99 or lower than 0.01, an insufficient visible light activity may be observed.

It is preferred that a concentration of both the first and second titanium oxide fine particles in the photocatalyst titanium oxide fine particle dispersion liquid be 0.01 to 20% by mass, particularly preferably 0.5 to 10% by mass, in terms of ease in producing a photocatalyst thin film having a given thickness.

Further, a binder may also be added to the titanium oxide fine particle dispersion liquid for the purpose of making it easy to apply the dispersion liquid to the surfaces of later-described various members, and allow the fine particles to adhere thereto. Examples of the binder include metal compound-based binders containing silicon, aluminum, titanium, zirconium or the like; and organic resin-based binders containing an acrylic resin, a urethane resin or the like.

It is preferred that the binder be added and used in a manner such that a mass ratio between the binder and titanium oxide [titanium oxide/binder] will fall into a range of 99 to 0.01, more preferably 9 to 0.1, even more preferably 2.5 to 0.4. This is because if the mass ratio is greater than 99, the titanium oxide fine particles may adhere to the surfaces of various members in an insufficient manner; and if the mass ratio is lower than 0.01, an insufficient visible light activity may be observed.

Particularly, in order to obtain an excellent photocatalyst thin film having a high photocatalytic action and transparency, it is preferred that a silicon compound-based binder be added and used in a manner such that the mass ratio (titanium oxide/silicon compound-based binder) will fall into the range of 99 to 0.01, more preferably 9 to 0.1, even more preferably 2.5 to 0.4. Here, the silicon compound-based binder refers to a colloid dispersion liquid, solution or emulsion of a solid or liquid silicon compound capable of being contained in an aqueous dispersion medium, specific examples of which include a colloidal silica (preferable particle size 1 to 150 nm); solutions of silicate salts such as silicate; silane and siloxane hydrolysate emulsions; a silicone resin emulsion; and emulsions of copolymers of silicone resins and other resins, such as a silicone-acrylic resin copolymer and a silicone-urethane resin copolymer.

### <Method for Producing Titanium Oxide Fine Particle Dispersion Liquid>

The titanium oxide fine particle dispersion liquid of the present invention is prepared by a production method in which a first titanium oxide fine particle dispersion liquid and a second titanium oxide fine particle dispersion liquid are separately produced, followed by mixing the first titanium oxide fine particle dispersion liquid and the second titanium oxide fine particle dispersion liquid.

As a method for producing the titanium oxide fine particle dispersion liquid when the first titanium oxide fine particles are titanium oxide fine particles with a tin component and a visible light responsiveness-enhancing transition metal component(s) solid-dissolved therein, there may be specifically employed, for example, a production method having the following steps (1) to (5).

(1) A step of producing a tin and transition metal component-containing peroxotitanic acid solution from a raw material titanium compound, tin compound, transition metal compound, basic substance, hydrogen peroxide and aqueous dispersion medium.

(2) A step of obtaining a tin and transition metal component-containing titanium oxide fine particle dispersion liquid by heating the tin and transition metal component-containing peroxotitanic acid solution produced in the step (1) at 80 to 250° C. under a controlled pressure.

(3) A step of producing an iron and silicon component-containing peroxotitanic acid solution from a raw material titanium compound, iron compound, silicon compound, basic substance, hydrogen peroxide and aqueous dispersion medium.

(4) A step of obtaining an iron and silicon component-containing titanium oxide fine particle dispersion liquid by heating the iron and silicon component-containing peroxotitanic acid solution produced in the step (3) at 80 to 250° C. under a controlled pressure.

(5) A step of mixing the two kinds of titanium oxide fine particle dispersion liquids separately produced in the steps (2) and (4).

The steps (1) and (2) are steps for obtaining the first titanium oxide fine particle dispersion liquid; the steps (3) and (4) are steps for obtaining the second titanium oxide fine particle dispersion liquid; and the step (5) is a step for eventually obtaining the dispersion liquid containing the first titanium oxide fine particles and the second titanium oxide fine particles.

As described above, as the transition metal compound used in the step (1), it is preferred that at least one of a molybdenum compound, tungsten compound and vanadium compound be used; each step is described in detail hereunder on such premise.

### Step (1):

In the step (1), the transition metal component and tin component-containing peroxotitanic acid solution is produced by reacting the raw material titanium compound, transition metal compound, tin compound, basic substance and hydrogen peroxide in the aqueous dispersion medium.

As a reaction method, there may be employed any of the following methods (i) to (iii).

(i) A method where the transition metal compound and tin compound are added and dissolved with respect to the raw material titanium compound and basic substance in the aqueous dispersion medium to obtain a transition metal component and tin component-containing titanium hydroxide, followed by removing impurity ions other than metal ions to be contained, and then adding hydrogen peroxide to obtain a transition metal component and tin component-containing peroxotitanic acid.

(ii) A method where the basic substance is added to the raw material titanium compound in the aqueous dispersion medium to obtain a titanium hydroxide, impurity ions other than metal ions to be contained are then removed, followed by adding the transition metal compound and tin compound, and then adding hydrogen peroxide to obtain a transition metal component and tin component-containing peroxotitanic acid.

(iii) A method where the basic substance is added to the raw material titanium compound in the aqueous dispersion medium to obtain a titanium hydroxide, impurity ions other than metal ions to be contained are then removed, hydrogen peroxide is then added to obtain a peroxotitanic acid, followed by adding the transition metal compound and tin compound to obtain a transition metal component and tin component-containing peroxotitanic acid.

Here, in the first part of the description of the method (i), “the raw material titanium compound and basic substance in the aqueous dispersion medium” may be prepared as two separate liquids of aqueous dispersion media such as “an aqueous dispersion medium with the raw material titanium compound dispersed therein” and “an aqueous dispersion medium with the basic substance dispersed therein,” and each of the transition metal compound and tin compound may then be dissolved in one or both of these two liquids in accordance with the solubility of each of the transition metal compound and tin compound in these two liquids before mixing the two.

In this way, after obtaining the transition metal component and tin component-containing peroxotitanic acid, by subjecting such peroxotitanic acid to a later-described hydrothermal reaction in the step (2), there can be obtained titanium oxide fine particles with the various metals solid-dissolved in titanium oxide.

Here, examples of the raw material titanium compound include titanium chlorides; inorganic acid salts of titanium, such as titanium nitrate and titanium sulfate; organic acid salts of titanium, such as titanium formate, titanium citrate, titanium oxalate, titanium lactate and titanium glycolate; and titanium hydroxides precipitated by hydrolysis reactions as a result of adding alkalis to aqueous solutions of these chlorides and salts. There may be used one of them or a combination of two or more of them. Particularly, it is preferred that titanium chlorides (TiCl₃, TiCl₄) be used.

As for each of the transition metal compound, tin compound and aqueous dispersion medium, those described above are used at the compositions described above. Here, it is preferred that a concentration of a raw material titanium compound aqueous solution composed of the raw material titanium compound and aqueous dispersion medium be not higher than 60% by mass, particularly preferably not higher than 30% by mass. A lower limit of the concentration is appropriately determined; it is preferred that the lower limit be not lower than 1% by mass in general.

The basic substance is to smoothly turn the raw material titanium compound into a titanium hydroxide, examples of which include hydroxides of alkali metals or alkaline earth metals, such as sodium hydroxide and potassium hydroxide; and amine compounds such as ammonia, alkanolamine and alkylamine. Among these examples, it is particularly preferred that ammonia be used and be used in such an amount that the pH level of the raw material titanium compound aqueous solution will be 7 or higher, particularly 7 to 10. Here, the basic substance, together with the aqueous dispersion medium, may be turned into an aqueous solution having a proper concentration before use.

Hydrogen peroxide is to convert the raw material titanium compound or titanium hydroxide into a peroxotitanic acid i.e. a titanium oxide compound having a Ti—O—O—Ti bond, and is normally used in the form of a hydrogen peroxide water. It is preferred that hydrogen peroxide be added in an amount of 1.5 to 20 times the molar amount of a total substance amount of Ti, the transition metal and Sn. Further, in the reaction where hydrogen peroxide is added to turn the raw material titanium compound or titanium hydroxide into the peroxotitanic acid, it is preferred that a reaction temperature be 5 to 80° C., and that a reaction time be 30 min to 24 hours.

The transition metal component and tin component-containing peroxotitanic acid solution thus obtained may also contain an alkaline substance or acidic substance for the purpose of pH adjustment or the like. Here, examples of the alkaline substance include ammonia, sodium hydroxide, calcium hydroxide and alkylamine; examples of the acidic substance include inorganic acids such as sulfuric acid, nitric acid, hydrochloric acid, carbonic acid, phosphoric acid and hydrogen peroxide, and organic acids such as formic acid, citric acid, oxalic acid, lactic acid and glycolic acid. In this case, it is preferred that pH of the transition metal component and tin component-containing peroxotitanic acid solution obtained be 1 to 9, particularly preferably 4 to 7, in terms of safety in handling.

### Step (2):

In the step (2), the transition metal component and tin component-containing peroxotitanic acid solution obtained in the step (1) is subjected to a hydrothermal reaction under a controlled pressure and at a temperature of 80 to 250° C., preferably 100 to 250° C. for 0.01 to 24 hours. An appropriate reaction temperature is 80 to 250° C. in terms of reaction efficiency and reaction controllability; as a result, the transition metal component and tin component-containing peroxotitanic acid will be converted into transition metal and tin component-containing titanium oxide fine particles. Here, the expression “under a controlled pressure” refers to a condition where if the reaction temperature is greater than the boiling point of the dispersion medium, a pressure will be applied in a proper manner such that the reaction temperature will be maintained; and even a condition where if the reaction temperature is not higher than the boiling point of the dispersion medium, atmospheric pressure will be used for control. The pressure employed here is normally about 0.12 to 4.5 MPa, preferably about 0.15 to 4.5 MPa, more preferably about 0.20 to 4.5 MPa. The reaction time is preferably 1 min to 24 hours. By this step (2), there can be obtained a dispersion liquid of the transition metal component and tin component-containing titanium oxide fine particles as the first titanium oxide fine particles.

It is preferred that the particle diameter of the titanium oxide fine particles obtained here fall into the ranges described above; the particle diameter can be controlled by adjusting the reaction condition(s), for example, the particle diameter can be made smaller by shortening the reaction time and a temperature rise time.

### Step (3):

In the step (3), the iron component and silicon component-containing peroxotitanic acid solution is produced by reacting the raw material titanium compound, iron compound, silicon compound, basic substance and hydrogen peroxide in the aqueous dispersion medium, separately from the steps (1) and (2). As a reaction method, there may be used the exact same method(s) as the step (1) except that an iron compound and silicon compound are now used instead of the transition metal compound and tin compound used in the step (1).

That is, as for the raw material titanium compound (identical to the raw material titanium compound of the first titanium oxide), iron compound, silicon compound, aqueous dispersion medium, basic substance and hydrogen peroxide as starting materials, those described above are used at the composition(s) described above, and are to be subjected to the reaction at the abovementioned temperature for the abovementioned period of time.

The iron component and silicon component-containing peroxotitanic acid solution thus obtained may also contain an alkaline substance or acidic substance for the purpose of pH adjustment or the like. These alkaline substance and acidic substance may employ those similar to the ones described above, and pH adjustment here may be carried out in a similar manner as above.

### Step (4):

In the step (4), the iron component and silicon component-containing peroxotitanic acid solution obtained in the step (3) is subjected to a hydrothermal reaction under a controlled pressure and at a temperature of 80 to 250° C., preferably 100 to 250° C. for 0.01 to 24 hours. An appropriate reaction temperature is 80 to 250° C. in terms of reaction efficiency and reaction controllability; as a result, the iron and silicon component-containing peroxotitanic acid will be converted into iron and silicon component-containing titanium oxide fine particles. Here, the expression “under a controlled pressure” refers to a condition where if the reaction temperature is greater than the boiling point of the dispersion medium, a pressure will be applied in a proper manner such that the reaction temperature will be maintained; and even a condition where if the reaction temperature is not higher than the boiling point of the dispersion medium, atmospheric pressure will be used for control. The pressure employed here is normally about 0.12 to 4.5 MPa, preferably about 0.15 to 4.5 MPa, more preferably about 0.20 to 4.5 MPa. The reaction time is preferably 1 min to 24 hours. By this step (4), there can be obtained a dispersion liquid of the iron and silicon component-containing titanium oxide fine particles as the second titanium oxide fine particles.

It is preferred that the particle diameter of the titanium oxide fine particles obtained here also fall into the ranges described above; the particle diameter can be controlled by adjusting the reaction condition(s), for example, the particle diameter can be made smaller by shortening the reaction time and the temperature rise time.

### Step (5):

In the step (5), the first titanium oxide fine particle dispersion liquid obtained in the steps (1) and (2) and the second titanium oxide fine particle dispersion liquid obtained in the steps (3) and (4) are mixed. No particular restrictions are imposed on a mixing method; there may be used a method of performing stirring with a stirrer, or a method of performing dispersion with an ultrasonic disperser. It is preferred that a temperature at the time of mixing be 20 to 100° C., and that a mixing time be 1 min to 3 hours. In terms of a mixing ratio, mixing may be performed in such a manner that the mass ratio between the titanium oxide fine particles in each titanium oxide fine particle dispersion liquid shall fall into the aforementioned ranges of mass ratio.

The mass of the titanium oxide fine particles contained in each titanium oxide fine particle dispersion liquid can be calculated from the mass and concentration of each titanium oxide fine particle dispersion liquid. Here, a method for measuring the concentration of the titanium oxide fine particle dispersion liquid is such that part of the titanium oxide fine particle dispersion liquid is sampled, and the concentration is then calculated with the following formula based on the mass of a non-volatile content (titanium oxide fine particles) after volatilizing the solvent by performing heating at 105° C. for 3 hours and the mass of the titanium oxide fine particle dispersion liquid sampled.

Concentration of titanium oxide fine particle dispersion liquid(%)=[mass of not-volatile content(g)/mass of titanium oxide fine particle dispersion liquid(g)]×100

As described above, it is preferred that the concentration of both the first and second titanium oxide fine particles in the titanium oxide fine particle dispersion liquid thus prepared be 0.01 to 20% by mass, particularly preferably 0.5 to 10% by mass, in terms of ease in producing a photocatalyst thin film having a given thickness. As for concentration adjustment, if the concentration is higher than a desired concentration, the concentration can be lowered via dilution by adding an aqueous solvent; if the concentration is lower than a desired concentration, the concentration can be raised by either volatilizing or filtering out the aqueous solvent. Here, the concentration can be calculated in the above manner.

Further, if adding the abovementioned binder enhancing a film forming capability, it is preferred that a solution of the binder (aqueous binder solution) be added to the titanium oxide fine particle dispersion liquid whose concentration has been adjusted in the above manner, so that the binder will be at a desired concertation after mixing.

### <Member Having Photocatalyst Thin Film on Surface>

The titanium oxide fine particle dispersion liquid of the present invention can be used to form photocatalyst films on the surfaces of various members. Here, no particular restrictions are imposed on the various members; examples of the materials of the members may include organic materials and inorganic materials. They may have various shapes depending on the purposes and uses thereof.

Examples of the organic materials include synthetic resin materials such as polyvinyl chloride resin (PVC), polyethylene (PE), polypropylene (PP), polycarbonate (PC), an acrylic resin, polyacetal, a fluorocarbon resin, a silicone resin, an ethylene-vinyl acetate copolymer (EVA), an acrylonitrile-butadiene rubber (NBR), polyethylene terephthalate (PET), polyethylene naphthalate (PEN), polyvinyl butyral (PVB), an ethylene-vinyl alcohol copolymer (EVOH), a polyimide resin, polyphenylene sulfide (PPS), polyetherimide (PEI), polyetheretherimide (PEEI), polyetheretherketone (PEEK), a melamine resin, a phenolic resin and an acrylonitrile-butadiene-styrene (ABS) resin; natural materials such as a natural rubber; or semisynthetic materials of the abovelisted synthetic resin materials and natural materials. It is possible that these materials have already been turned into commercial products having given shapes and structures, such as a film, sheet, fiber material, fiber product and other molded products as well as laminates.

Examples of the inorganic materials include non-metallic inorganic materials and metallic inorganic materials. Examples of the non-metallic inorganic materials include glass, ceramics and stone materials. It is possible that these materials have already been turned into commercial products having various shapes, such as tiles, glass, mirrors, walls and decorative materials. Examples of the metallic inorganic materials include a cast iron, steel, iron, iron alloy, aluminum, aluminum alloy, nickel, nickel alloy and zinc die-cast. They may be plated with any of the above metal inorganic materials or coated with any of the above organic materials, or may be used to plate the surfaces of the above organic materials or non-metallic inorganic materials.

The titanium oxide fine particle dispersion liquid of the present invention is especially useful for forming a transparent photocatalyst thin film on a polymer film such as a PET film even among the various members listed above.

As a method for forming photocatalyst thin films on the surfaces of the various members, the titanium oxide fine particle dispersion liquid may, for example, be applied to the surface of a member by a known application method such as spray coating and dip coating, followed by performing drying by a known drying method such as far-infrared drying, IH drying and hot-air drying. The thickness of the photocatalyst thin film may be determined variously; it is preferred that the thickness of the photocatalyst thin film normally fall into a range of 10 nm to 10 μm.

In this way, there can be formed a coating film of the titanium oxide fine particle mixture. In this case, if a binder is contained in the dispersion liquid by the aforementioned amount, there can be formed a coating film containing the titanium oxide fine particle mixture and the binder.

The photocatalyst thin film thus formed is transparent, and is capable of not only imparting a favorable photocatalytic action under lights in the ultraviolet region (wavelength 10 to 400 nm) as are the conventional cases, but also achieving a superior photocatalytic action even under lights in the visible region (wavelength 400 to 800 nm) of which a sufficient photocatalytic action has never been able to be achieved with a conventional photocatalyst. The various members with the photocatalyst thin films formed thereon decompose organic substances that have adsorbed to the surfaces thereof with the aid of the photocatalytic action of titanium oxide, thereby bringing about, for example, a cleaning, deodorizing and antibacterial effects to the surfaces of the members.

### WORKING EXAMPLES

The present invention is described in detail hereunder with reference to working and comparative examples. However, the present invention is not limited to the following working examples. Various measurements in the present invention were performed as follows.

### (1) 50% and 90% Cumulative Distribution Diameters of Titanium Oxide Fine Particles in Dispersion Liquid

D₅₀ and D₉₀ of the titanium oxide fine particles in the dispersion liquid were calculated as 50% and 90% cumulative distribution diameters on volumetric basis that are measured by a dynamic light scattering method using a laser light, by means of a particle size distribution measurement device (ELSZ-2000ZS by Otsuka Electronics Co., Ltd.).

### (2) Acetaldehyde Gas Decomposition Capability Test of Photocatalyst Thin Film

The activity of a photocatalyst thin film produced by applying the dispersion liquid and then drying the same was evaluated through a decomposition reaction of an acetaldehyde gas. The evaluation was performed by a batch-wise gas decomposition capability evaluation method.

Specifically, an evaluation sample was at first placed into a 5 L stainless cell equipped with a quartz glass window, the evaluation sample being that prepared by forming, on the entire surface of a PET film of an A4 size (210 mm×297 mm), a photocatalyst thin film containing about 20 mg of photocatalyst fine particles in terms of dry mass. This cell was then filled with an acetaldehyde gas having an initial concentration with a humidity thereof being controlled to 50%, followed by performing light irradiation with a light source provided at an upper portion of the cell. As a result of having the acetaldehyde gas decomposed by the photocatalyst on the thin film, the acetaldehyde gas concentration in the cell will decrease. There, by measuring this concentration, a decomposition amount of the acetaldehyde gas can be obtained. The acetaldehyde gas concentration was measured by a photoacoustic multi-gas monitor (product name “INNOVA1412” by LumaSense Technologies), and there was measured a time it took for the acetaldehyde gas concentration to be reduced from the initial concentration to 1 ppm. The test was performed for 24 hours from the start of the light irradiation.

In a photocatalytic activity evaluation under ultraviolet irradiation, a UV fluorescent lamp (product model number “FL10 BLB” by Toshiba Lighting & Technology Corporation) was used as a light source, and ultraviolet irradiation was carried out at an irradiance of 0.5 mW/cm². At that time, the initial concentration of the acetaldehyde in the cell was set to 20 ppm.

Further, in a photocatalytic activity evaluation under visible light irradiation, an LED (product model number “TH-211 x200SW” by CCS Inc., spectral distribution: 400 to 800 nm) was used as a light source, and visible light irradiation was carried out at an illuminance of 30,000 Lx. At that time, the initial concentration of the acetaldehyde in the cell was set to 5 ppm.

### (3) Identification of Crystal Phase of Titanium Oxide Fine Particles

The crystal phase of the titanium oxide fine particles was identified in a way where the dispersion liquid of the titanium oxide fine particles obtained was dried at 105° C. for three hours to obtain a titanium oxide fine particle powder, followed by collecting the titanium oxide fine particle powder so as to subject the same to powder X-ray diffraction analysis, using a diffraction device (product name “Benchtop X-ray diffractometer D2 PHASER” by BRUKER AXS Co., Ltd.).

### (4) Preparation of First Titanium Oxide Fine Particle Dispersion Liquid

### Preparation Example 1-1

<Preparation of Dispersion Liquid of Titanium Oxide Fine Particles with Tin and Molybdenum Solid-Dissolved Therein>

Tin chloride (IV) was added to and dissolved in a 36% by mass titanium chloride (IV) aqueous solution so that Ti/Sn (molar ratio) would be 20, followed by diluting the solution thus prepared 10 times with a pure water, and then neutralizing and hydrolyzing the same by gradually adding a 10% by mass ammonia water, thereby obtaining a precipitate of a tin-containing titanium hydroxide. pH at that time was 8. The precipitate thus obtained was then deionized by repeating the addition of pure water and decantation. Sodium molybdate (VI) was then added to the deionized precipitate of the tin-containing titanium hydroxide so that Ti/Mo (molar ratio) would be 250 with respect to the Ti component in the titanium chloride (IV) aqueous solution. A 35% by mass hydrogen peroxide water was then added so that H₂O₂/(Ti+Sn+Mo) (molar ratio) would be 10, followed by performing stirring at 60° C. for two hours so as to sufficiently react the solution, thereby obtaining an orange transparent tin and molybdenum-containing peroxotitanic acid solution (1a).

Next, 400 mL of the tin and molybdenum-containing peroxotitanic acid solution (1a) was put into a 500 mL autoclave so as to be subjected to a hydrothermal treatment at 150° C. for 90 min, followed by adding a pure water to adjust the concentration thereof, thereby obtaining a dispersion liquid of titanium oxide fine particles (1A) with tin and molybdenum solid-dissolved therein (solid content concentration 1% by mass). As a result of performing powder X-ray diffraction analysis on the titanium oxide fine particles (1A), there were only observed peaks of a rutile-type titanium oxide; it was confirmed that tin and molybdenum was solid-dissolved in titanium oxide.

### Preparation Example 1-2

<Preparation of Dispersion Liquid of Titanium Oxide Fine Particles with Tin, Molybdenum and Tungsten Solid-Dissolved Therein>

A dispersion liquid of titanium oxide fine particles (1B) with tin, molybdenum and tungsten solid-dissolved therein (solid content concentration 1% by mass) was obtained in a similar manner as the preparation example 1-1, except that tin chloride (IV) was added so that Ti/Sn (molar ratio) would be 10; that sodium molybdate (VI) and sodium tungstate (VI) were added to the deionized precipitate of the tin-containing titanium hydroxide so that Ti/Mo (molar ratio) would be 100, and Ti/W (molar ratio) would be 250; and that the hydrothermal treatment time was 120 min. As a result of performing powder X-ray diffraction analysis on the titanium oxide fine particles (1B), there were only observed peaks of a rutile-type titanium oxide; it was confirmed that tin, molybdenum and tungsten was solid-dissolved in titanium oxide.

### Preparation Example 1-3

<Preparation of Dispersion Liquid of Titanium Oxide Fine Particles with Tin, Molybdenum and Vanadium Solid-Dissolved Therein>

Tin chloride (IV) was added to and dissolved in a 36% by mass titanium chloride (IV) aqueous solution so that Ti/Sn (molar ratio) would be 33, followed by diluting the solution thus prepared 10 times with a pure water. Next, gradually added to this aqueous solution for the purpose of neutralization and hydrolyzation was a 10% by mass ammonia water with sodium vanadate (V) already dissolved therein so that Ti/V (molar ratio) would be 2,000 with respect to the Ti component in the titanium chloride (IV) aqueous solution, thereby obtaining a precipitate of a tin and vanadium-containing titanium hydroxide. pH at that time was 8. The precipitate thus obtained was then deionized by repeating the addition of pure water and decantation. Sodium molybdate (VI) was then added to the deionized precipitate of the tin and vanadium-containing titanium hydroxide so that Ti/Mo (molar ratio) would be 500. A 35% by mass hydrogen peroxide water was then added so that H₂O₂/(Ti+Sn+Mo+V) (molar ratio) would be 10, followed by performing stirring at 50° C. for three hours so as to sufficiently react the solution, thereby obtaining an orange transparent tin, molybdenum and vanadium-containing peroxotitanic acid solution (1c).

Next, 400 mL of the tin, molybdenum and vanadium-containing peroxotitanic acid solution (1c) was put into a 500 mL autoclave so as to be subjected to a hydrothermal treatment at 160° C. for 60 min, followed by adding a pure water to adjust the concentration thereof, thereby obtaining a dispersion liquid of titanium oxide fine particles (1C) with tin, molybdenum and vanadium solid-dissolved therein (solid content concentration 1% by mass). As a result of performing powder X-ray diffraction analysis on the titanium oxide fine particles (1C), there were only observed peaks of an anatase-type titanium oxide and a rutile-type titanium oxide; it was confirmed that tin, molybdenum and vanadium was solid-dissolved in titanium oxide.

### Preparation Example 1-4

<Preparation of Dispersion Liquid of Titanium Oxide Fine Particles with Tin and Molybdenum Solid-Dissolved Therein>

Tin chloride (IV) was added to and dissolved in a 36% by mass titanium chloride (IV) aqueous solution so that Ti/Sn (molar ratio) would be 20, followed by diluting the solution thus prepared 10 times with a pure water, and then neutralizing and hydrolyzing the same by gradually adding a 10% by mass ammonia water, thereby obtaining a precipitate of a tin-containing titanium hydroxide. pH at that time was 8. The precipitate thus obtained was then deionized by repeating the addition of pure water and decantation. Sodium molybdate (VI) was then added to the deionized precipitate of the tin-containing titanium hydroxide so that Ti/Mo (molar ratio) would be 50 with respect to the Ti component in the titanium chloride (IV) aqueous solution. A 35% by mass hydrogen peroxide water was then added so that H₂O₂/(Ti+Sn+Mo) (molar ratio) would be 12, followed by performing stirring at 60° C. for two hours so as to sufficiently react the solution, thereby obtaining an orange transparent tin and molybdenum-containing peroxotitanic acid solution (1d).

Next, 400 mL of the tin and molybdenum-containing peroxotitanic acid solution (1d) was put into a 500 mL autoclave so as to be subjected to a hydrothermal treatment at 150° C. for 90 min, followed by adding a pure water to adjust the concentration thereof, thereby obtaining a dispersion liquid of titanium oxide fine particles (1D) with tin and molybdenum solid-dissolved therein (solid content concentration 1% by mass). As a result of performing powder X-ray diffraction analysis on the titanium oxide fine particles (1D), there were only observed peaks of a rutile-type titanium oxide; it was confirmed that tin and molybdenum was solid-dissolved in titanium oxide.

### Preparation Example 1-5

<Preparation of Dispersion Liquid of Titanium Oxide Fine Particles with Tin and Tungsten Solid-Dissolved Therein>

A dispersion liquid of titanium oxide fine particles (1E) with tin and tungsten solid-dissolved therein (solid content concentration 1% by mass) was obtained in a similar manner as the preparation example 1-1, except that tin chloride (IV) was added so that Ti/Sn (molar ratio) would be 50, and that sodium tungstate (VI) was added to the deionized precipitate of the tin-containing titanium hydroxide so that Ti/W (molar ratio) would be 33. As a result of performing powder X-ray diffraction analysis on the titanium oxide fine particles (1E), there were only observed peaks of an anatase-type titanium oxide and a rutile-type titanium oxide; it was confirmed that tin and tungsten was solid-dissolved in titanium oxide.

### Preparation Example 1-6

<Preparation of Dispersion Liquid of Titanium Oxide Fine Particles with Tin Solid-Dissolved Therein>

A dispersion liquid of titanium oxide fine particles (1F) with tin solid-dissolved therein (solid content concentration 1% by mass) was obtained in a similar manner as the preparation example 1-1, except that sodium molybdate (VI) was not added. As a result of performing powder X-ray diffraction analysis on the titanium oxide fine particles (1F), there were only observed peaks of a rutile-type titanium oxide; it was confirmed that tin was solid-dissolved in titanium oxide.

### Preparation Example 1-7

<Preparation of Dispersion Liquid of Titanium Oxide Fine Particles with Molybdenum Solid-Dissolved Therein>

A dispersion liquid of titanium oxide fine particles (1G) with molybdenum solid-dissolved therein (solid content concentration 1% by mass) was obtained in a similar manner as the preparation example 1-1, except that tin chloride (IV) was not added. As a result of performing powder X-ray diffraction analysis on the titanium oxide fine particles (1G), there were only observed peaks of an anatase-type titanium oxide; it was confirmed that molybdenum was solid-dissolved in titanium oxide.

### Preparation Example 1-8

<Preparation of Dispersion Liquid of Titanium Oxide Fine Particles with Tungsten Solid-Dissolved Therein>

A dispersion liquid of titanium oxide fine particles (1H) with tungsten solid-dissolved therein (solid content concentration 1% by mass) was obtained in a similar manner as the preparation example 1-5, except that tin chloride (IV) was not added, and that sodium tungstate (VI) was added to the deionized precipitate of the titanium hydroxide so that Ti/W (molar ratio) would be 100. As a result of performing powder X-ray diffraction analysis on the titanium oxide fine particles (1H), there were only observed peaks of an anatase-type titanium oxide; it was confirmed that tungsten was solid-dissolved in titanium oxide.

### Preparation Example 1-9

### <Preparation of Dispersion Liquid of Titanium Oxide Fine Particles>

After diluting a 36% by mass titanium chloride (IV) aqueous solution 10 times with a pure water, a 10% by mass ammonia water was gradually added so as to neutralize and hydrolyze the same, thereby obtaining a precipitate of titanium hydroxide. pH at that time was 8.5. The precipitate thus obtained was then deionized by repeating the addition of pure water and decantation. A 35% by mass hydrogen peroxide water was then added to the deionized precipitate of titanium hydroxide so that H₂O₂/Ti (molar ratio) would be 8, followed by performing stirring at 60° C. for two hours so as to sufficiently react the solution, thereby obtaining an orange transparent peroxotitanic acid solution (1i).

Next, 400 mL of the peroxotitanic acid solution (ii) was put into a 500 mL autoclave so as to be subjected to a hydrothermal treatment at 130° C. for 90 min, followed by adding a pure water to adjust the concentration thereof, thereby obtaining a dispersion liquid of titanium oxide fine particles (10 (solid content concentration 1% by mass). As a result of performing powder X-ray diffraction analysis on the titanium oxide fine particles (1I), there were only observed peaks of an anatase-type titanium oxide.

### Preparation Example 1-10

<Preparation of Dispersion Liquid of Titanium Oxide Fine Particles with Tin Solid-Dissolved Therein and with Molybdenum Component Adsorbed to (=Supported on) Surfaces>

Sodium molybdate (VI) was added to the dispersion liquid prepared in the preparation example 1-6, which is the dispersion liquid of the titanium oxide fine particles (1F) with tin solid-dissolved therein (solid content concentration 1% by mass), so that Ti/Mo (molar ratio) would be 250 with respect to the Ti component in the titanium oxide fine particles, thereby obtaining a titanium oxide fine particle dispersion liquid (1J).

### (5) Preparation of Second Titanium Oxide Fine Particle Dispersion Liquid

### Preparation Example 2-1

<Preparation of Dispersion Liquid of Titanium Oxide Fine Particles with Iron and Silicon Solid-Dissolved Therein>

Iron chloride (III) was added to a 36% by mass titanium chloride (IV) aqueous solution so that Ti/Fe (molar ratio) would be 10, followed by diluting the solution thus prepared 10 times with a pure water. Next, gradually added to this aqueous solution for the purpose of neutralization and hydrolyzation was a 10% by mass ammonia water with sodium silicate already dissolved therein so that Ti/Si (molar ratio) would be 10 with respect to the Ti component in the titanium chloride (IV) aqueous solution, thereby obtaining a precipitate of an iron and silicon-containing titanium hydroxide. pH at that time was 8. The precipitate thus obtained was then deionized by repeating the addition of pure water and decantation. A 35% by mass hydrogen peroxide water was then added to the deionized precipitate of the iron and silicon-containing titanium hydroxide so that H₂O₂/(Ti+Fe+Si) (molar ratio) would be 12, followed by performing stirring at 50° C. for two hours so as to sufficiently react the solution, thereby obtaining an orange transparent iron and silicon-containing peroxotitanic acid solution (2a).

Next, 400 mL of the iron and silicon-containing peroxotitanic acid solution (2a) was put into a 500 mL autoclave so as to be subjected to a hydrothermal treatment at 130° C. for 90 min, followed by adding a pure water to adjust the concentration thereof, thereby obtaining a dispersion liquid of titanium oxide fine particles (2A) with iron and silicon solid-dissolved therein (solid content concentration 1% by mass). As a result of performing powder X-ray diffraction analysis on the titanium oxide fine particles (2A), there were only observed peaks of an anatase-type titanium oxide; it was confirmed that iron and silicon was solid-dissolved in titanium oxide.

### Preparation Example 2-2

<Preparation of Dispersion Liquid of Titanium Oxide Fine Particles with Iron, Silicon and Tungsten Solid-Dissolved Therein>

Iron chloride (III) was added to a 36% by mass titanium chloride (IV) aqueous solution so that Ti/Fe (molar ratio) would be 5, followed by diluting the solution thus prepared 10 times with a pure water. Next, gradually added to this aqueous solution for the purpose of neutralization and hydrolyzation was a 10% by mass ammonia water with sodium silicate already dissolved therein so that Ti/Si (molar ratio) would be 5 with respect to the Ti component in the titanium chloride (IV) aqueous solution, thereby obtaining a precipitate of an iron and silicon-containing titanium hydroxide. pH at that time was 8. The precipitate thus obtained was then deionized by repeating the addition of pure water and decantation. After adding sodium tungstate (VI) to the deionized precipitate of the iron and silicon-containing titanium hydroxide so that Ti/W (molar ratio) would be 200, a 35% by mass hydrogen peroxide water was then added thereto so that H₂O₂/(Ti+Fe+Si+W) (molar ratio) would be 15, followed by performing stirring at 50° C. for two hours so as to sufficiently react the solution, thereby obtaining an orange transparent iron, silicon and tungsten-containing peroxotitanic acid solution (2b).

Next, 400 mL of the iron, silicon and tungsten-containing peroxotitanic acid solution (2b) was put into a 500 mL autoclave so as to be subjected to a hydrothermal treatment at 130° C. for 120 min, followed by adding a pure water to adjust the concentration thereof, thereby obtaining a dispersion liquid of titanium oxide fine particles (2B) with iron, silicon and tungsten solid-dissolved therein (solid content concentration 1% by mass). As a result of performing powder X-ray diffraction analysis on the titanium oxide fine particles (2B), there were only observed peaks of an anatase-type titanium oxide; it was confirmed that iron, silicon and tungsten was solid-dissolved in titanium oxide.

### Preparation Example 2-3

<Preparation of Dispersion Liquid of Titanium Oxide Fine Particles with Iron and Silicon Solid-Dissolved Therein>

An orange transparent peroxotitanic acid solution (2c) was obtained in a similar manner as the preparation example 2-1, except that iron chloride (III) was added so that Ti/Fe (molar ratio) would be 5, and that sodium silicate was added so that Ti/Si (molar ratio) would be 20.

Next, 400 mL of the peroxotitanic acid solution (2c) was put into a 500 mL autoclave so as to be subjected to a hydrothermal treatment at 130° C. for 90 min, followed by adding a pure water to adjust the concentration thereof, thereby obtaining a dispersion liquid of titanium oxide fine particles (2C) (solid content concentration 1% by mass). As a result of performing powder X-ray diffraction analysis on the titanium oxide fine particles (2C), there were only observed peaks of an anatase-type titanium oxide.

### (6) Preparation of Titanium Oxide Fine Particle Dispersion Liquid for Comparative Example

### Preparation Example 3-1

<Preparation of Dispersion Liquid of Titanium Oxide Fine Particles with Iron Solid-Dissolved Therein>

A dispersion liquid of titanium oxide fine particles (3A) with iron solid-dissolved therein (solid content concentration 1% by mass) was obtained in a similar manner as the preparation example 2-1, except that sodium silicate was not added. As a result of performing powder X-ray diffraction analysis on the titanium oxide fine particles (3A), there were only observed peaks of an anatase-type titanium oxide; it was confirmed that iron was solid-dissolved in titanium oxide.

### Preparation Example 3-2

<Preparation of Dispersion Liquid of Titanium Oxide Fine Particles with Silicon Solid-Dissolved Therein>

A dispersion liquid of titanium oxide fine particles (3B) with silicon solid-dissolved therein (solid content concentration 1% by mass) was obtained in a similar manner as the preparation example 2-1, except that iron chloride (III) was not added. As a result of performing powder X-ray diffraction analysis on the titanium oxide fine particles (3B), there were only observed peaks of an anatase-type titanium oxide; it was confirmed that silicon was solid-dissolved in titanium oxide.

### Preparation Example 3-3

<Preparation of Dispersion Liquid of Titanium Oxide Fine Particles with Iron Solid-Dissolved Therein and with Silicon Component Adsorbed to (=Supported on) Surfaces>

Sodium silicate was added to the dispersion liquid prepared in the preparation example 3-1, which is the dispersion liquid of the titanium oxide fine particles (3A) with iron solid-dissolved therein (solid content concentration 1% by mass), so that Ti/Si (molar ratio) would be 10 with respect to the Ti component in the titanium oxide fine particles, thereby obtaining a titanium oxide fine particle dispersion liquid (3C).

### Preparation Example 3-4

<Preparation of Dispersion Liquid of Titanium Oxide Fine Particles with Silicon Solid-Dissolved Therein and with Iron Component Adsorbed to (=Supported on) Surfaces>

Iron chloride was added to the dispersion liquid prepared in the preparation example 3-2, which is the dispersion liquid of the titanium oxide fine particles (3B) with silicon solid-dissolved therein (solid content concentration 1% by mass), so that Ti/Fe (molar ratio) would be 10 with respect to the Ti component in the titanium oxide fine particles, thereby obtaining a titanium oxide fine particle dispersion liquid (3D). The titanium oxide fine particles in the titanium oxide fine particle dispersion liquid (3D) were confirmed to have agglutinated and precipitated.

Shown collectively in Table 1 are the raw material ratios, hydrothermal treatment conditions and dispersion particle diameters (D₅₀, D₉₀) of the titanium oxide fine particles prepared in each preparation example. The dispersion particle diameters were measured by a dynamic light scattering method using a laser light (ELSZ-2000ZS by Otsuka Electronics Co., Ltd.).

TABLE 1

| | Titanium | | | | | | | | | | |
|---|---|---|---|---|---|---|---|---|---|---|---|
| | oxide fine | | | | | | | Hydrothermal | | | |
| | particle | | | | | | | treatment | | | |
| Preparation | dispersion | Molar ratio | | | | | | Temperature | Time | D₅₀ | D₉₀ |
| example | liquid | Ti/Sn | Ti/Mo | Ti/W | Ti/V | Ti/Fe | Ti/Si | (° C.) | (min) | (nm) | (nm) |
| 1-1 | 1A | 20 | 250 | — | — | — | — | 150 | 90 | 8 | 13 |
| 1-2 | 1B | 10 | 100 | 250 | — | — | — | 150 | 120 | 7 | 12 |
| 1-3 | 1C | 33 | 500 | — | 2000 | — | — | 160 | 60 | 14 | 20 |
| 1-4 | 1D | 20 | 50 | — | — | — | — | 150 | 90 | 9 | 15 |
| 1-5 | 1E | 50 | — | 33 | — | — | — | 150 | 90 | 16 | 26 |
| 1-6 | 1F | 20 | — | — | — | — | — | 150 | 90 | 9 | 13 |
| 1-7 | 1G | — | 250 | — | — | — | — | 150 | 90 | 18 | 26 |
| 1-8 | 1H | — | — | 100 | — | — | — | 150 | 90 | 17 | 24 |
| 1-9 | 1I | — | — | — | — | — | — | 130 | 90 | 15 | 21 |
| 2-1 | 2A | — | — | — | — | 10 | 10 | 130 | 90 | 20 | 25 |
| 2-2 | 2B | — | — | 200 | — | 5 | 5 | 130 | 120 | 22 | 28 |
| 2-3 | 2C | — | — | — | — | 5 | 20 | 130 | 90 | 15 | 20 |
| 3-1 | 3A | — | — | — | — | 10 | — | 130 | 90 | 20 | 28 |
| 3-2 | 3B | — | — | — | — | — | 10 | 130 | 90 | 18 | 26 |

### (7) Preparation of Titanium Oxide Fine Particle Dispersion Liquid

### Working Example 1

The dispersion liquids of the titanium oxide fine particles (1A) and (2A) were mixed together so that a mass ratio between the titanium oxide fine particles (1A) and the titanium oxide fine particles (2A) would be (1A):(2A)=80:20, thereby obtaining a titanium oxide fine particle dispersion liquid (E-1).

### Working Example 2

The dispersion liquids of the titanium oxide fine particles (1A) and (2A) were mixed together so that a mass ratio between the titanium oxide fine particles (1A) and the titanium oxide fine particles (2A) would be (1A):(2A)=60:40, thereby obtaining a titanium oxide fine particle dispersion liquid (E-2).

### Working Example 3

The dispersion liquids of the titanium oxide fine particles (1B) and (2A) were mixed together so that a mass ratio between the titanium oxide fine particles (1B) and the titanium oxide fine particles (2A) would be (1B):(2A)=80:20, thereby obtaining a titanium oxide fine particle dispersion liquid (E-3).

### Working Example 4

The dispersion liquids of the titanium oxide fine particles (1C) and (2A) were mixed together so that a mass ratio between the titanium oxide fine particles (1C) and the titanium oxide fine particles (2A) would be (1C):(2A)=80:20, thereby obtaining a titanium oxide fine particle dispersion liquid (E-4).

### Working Example 5

The dispersion liquids of the titanium oxide fine particles (1A) and (2B) were mixed together so that a mass ratio between the titanium oxide fine particles (1A) and the titanium oxide fine particles (2B) would be (1A):(2B)=80:20, thereby obtaining a titanium oxide fine particle dispersion liquid (E-5).

### Working Example 6

The dispersion liquids of the titanium oxide fine particles (1D) and (2A) were mixed together so that a mass ratio between the titanium oxide fine particles (1D) and the titanium oxide fine particles (2A) would be (1D):(2A)=70:30, thereby obtaining a titanium oxide fine particle dispersion liquid (E-6).

### Working Example 7

The dispersion liquids of the titanium oxide fine particles (1E) and (2A) were mixed together so that a mass ratio between the titanium oxide fine particles (1E) and the titanium oxide fine particles (2A) would be (1E):(2A)=60:40, thereby obtaining a titanium oxide fine particle dispersion liquid (E-7).

### Working Example 8

The dispersion liquids of the titanium oxide fine particles (1A) and (2C) were mixed together so that a mass ratio between the titanium oxide fine particles (1A) and the titanium oxide fine particles (2C) would be (1A):(2C)=90:10, thereby obtaining a titanium oxide fine particle dispersion liquid (E-8).

### Working Example 9

A silicon compound-based (silica-based) binder (colloidal silica, product name: SNOWTEX 20 by Nissan Chemical Corporation) was added to and mixed with the titanium oxide fine particle dispersion liquid (E-1) so that TiO₂/SiO₂ (mass ratio) would be 1.5, thereby obtaining a binder-containing titanium oxide fine particle dispersion liquid (E-9).

### Working Example 10

The dispersion liquids of the titanium oxide fine particles (1F) and (2A) were mixed together so that a mass ratio between the titanium oxide fine particles (1F) and the titanium oxide fine particles (2A) would be (1F):(2A)=80:20, thereby obtaining a titanium oxide fine particle dispersion liquid (E-10).

### Working Example 11

The dispersion liquids of the titanium oxide fine particles (1J) and (2A) were mixed together so that a mass ratio between the titanium oxide fine particles (1J) and the titanium oxide fine particles (2A) would be (11):(2A)=80:20, thereby obtaining a titanium oxide fine particle dispersion liquid (E-11).

### Comparative Example 1

The dispersion liquids of the titanium oxide fine particles (1A) and (3A) were mixed together so that a mass ratio between the titanium oxide fine particles (1A) and the titanium oxide fine particles (3A) would be (1A):(3A)=80:20, thereby obtaining a titanium oxide fine particle dispersion liquid (C-1).

### Comparative Example 2

The dispersion liquids of the titanium oxide fine particles (1A) and (3B) were mixed together so that a mass ratio between the titanium oxide fine particles (1A) and the titanium oxide fine particles (3B) would be (1A):(3B)=80:20, thereby obtaining a titanium oxide fine particle dispersion liquid (C-2).

### Comparative Example 3

A titanium oxide fine particle dispersion liquid (C-3) was obtained only from the titanium oxide fine particles (1A).

### Comparative Example 4

A titanium oxide fine particle dispersion liquid (C-4) was obtained only from the titanium oxide fine particles (2A).

### Comparative Example 5

The dispersion liquids of the titanium oxide fine particles (1A) and (3C) were mixed together so that a mass ratio between the titanium oxide fine particles (1A) and the titanium oxide fine particles (3C) would be (1A):(3C)=80:20, thereby obtaining a titanium oxide fine particle dispersion liquid (C-5).

### Comparative Example 6

The dispersion liquids of the titanium oxide fine particles (1A) and (3D) were mixed together so that a mass ratio between the titanium oxide fine particles (1A) and the titanium oxide fine particles (3D) would be (1A):(3D)=80:20, thereby obtaining a titanium oxide fine particle dispersion liquid (C-6).

### Comparative Example 7

The dispersion liquids of the titanium oxide fine particles (1A) and (1I) were mixed together so that a mass ratio between the titanium oxide fine particles (1A) and the titanium oxide fine particles (1I) would be (1A):(1I)=80:20, thereby obtaining a titanium oxide fine particle dispersion liquid (C-7).

### Comparative Example 8

A titanium oxide fine particle dispersion liquid (C-8) was obtained in a similar manner as the working example 9, except that the titanium oxide fine particles (2A) were not added to the titanium oxide fine particles (1A).

### Comparative Example 9

A titanium oxide fine particle dispersion liquid (C-9) was obtained only from the titanium oxide fine particles (1B).

### Comparative Example 10

A titanium oxide fine particle dispersion liquid (C-10) was obtained only from the titanium oxide fine particles (1C).

### Comparative Example 11

A titanium oxide fine particle dispersion liquid (C-11) was obtained only from the titanium oxide fine particles (1D).

### Comparative Example 12

A titanium oxide fine particle dispersion liquid (C-12) was obtained only from the titanium oxide fine particles (1E).

### Comparative Example 13

A titanium oxide fine particle dispersion liquid (C-13) was obtained only from the titanium oxide fine particles (1F).

### (8) Production of Sample Member Having Photocatalyst Thin Film

A #7 wire bar coater was used to apply each titanium oxide fine particle dispersion liquid prepared in the working and comparative examples to a PET film of an A4 size in a manner such that there would be formed thereon a photocatalyst thin film (thickness: about 80 nm) containing 20 mg of photocatalyst titanium oxide fine particles, followed by performing drying in an oven set to 80° C. for an hour, thereby obtaining a sample member for use in evaluation of acetaldehyde gas decomposition capability.

### [Photocatalytic Capability Test Under UV Irradiation]

With regard to sample members having the photocatalyst thin films of the working examples 1, 8 and 9; as well as comparative examples 3, 7 and 8, an acetaldehyde decomposition test was performed under an irradiation of a UV fluorescent lamp. Evaluation was conducted based on the time it took for the acetaldehyde concentration to be reduced from 20 ppm which was an initial concentration to 1 ppm.

Shown collectively in Table 2 are the mixing ratios, dispersion particle diameters (D₅₀, D₉₀) and acetaldehyde gas decomposition test results of the titanium oxide fine particle dispersion liquids. The dispersion particle diameters were measured by a dynamic light scattering method using a laser light (ELSZ-2000ZS by Otsuka Electronics Co., Ltd.).

TABLE 2

| | | Titanium oxide fine | | | | | |
|---|---|---|---|---|---|---|---|
| | | particle dispersion liquid | | | Evaluation result | | |
| | Evaluation | | | Mixing | D₅₀ | D₉₀ | Time taken |
| | sample | Type | | ratio | (nm) | (nm) | to 1 ppm (h) |
| Working example 1 | E-1 | 1A | 2A | 80:20 | 10 | 15 | 1.5 |
| Working example 8 | E-8 | 1A | 2C | 90:10 | 9 | 14 | 2.7 |
| Comparative example 3 | C-3 | 1A | — | 100:0 | 8 | 13 | 3.3 |
| Comparative example 7 | C-7 | 1A | 1I | 80:20 | 11 | 16 | 3.1 |
| Working example 9 | E-9 | 1A | 2A | 80:20 | 11 | 17 | 3.9 |
| Comparative example 8 | C-8 | 1A | — | 100:0 | 12 | 20 | 15.5 |

As can be seen from the results of the working examples 1, 8 and comparative example 3, it was confirmed that by mixing the titanium oxide fine particles (2A) or (2C) with the iron component and silicon component solid-dissolved therein with the titanium oxide fine particles (1A), the photocatalytic activity had been enhanced as compared to when the titanium oxide fine particles (1A) were used alone. Further, as can be seen from the result of the comparative example 7, it was confirmed that such enhancement in activity was even superior to that when there were mixed the titanium oxide fine particles (10 with no iron and silicon solid-dissolved therein.

Similarly, as can be seen from the results of the working example 9 and comparative example 8, it was confirmed that even in the case of a binder-containing photocatalyst thin film, by mixing the titanium oxide fine particles (2A) with the iron component and silicon component solid-dissolved therein with the titanium oxide fine particles (1A), the photocatalytic activity had been enhanced significantly as compared to when the titanium oxide fine particles (1A) were used alone.

### [Photocatalytic Capability Test Under Visible Light Irradiation]

An acetaldehyde decomposition test was performed on the sample members having the photocatalyst thin films of the working and comparative examples under an irradiation of a visible light by LED. Evaluation was conducted based on the time it took for the acetaldehyde concentration to be reduced from 5 ppm which was an initial concentration to 1 ppm.

Here, cases where the acetaldehyde concentration failed to be reduced to 1 ppm in 24 hours were marked with “-” in a column titled “Time taken to be decomposed to 1 ppm” in Tables 3 and 4, and the corresponding concentrations are shown in a column titled “Concentration after 24 h” in these tables.

Shown collectively in Table 3 are the mixing ratios, dispersion particle diameters (D₅₀, D₉₀) and acetaldehyde gas decomposition test results of the titanium oxide fine particle dispersion liquids, when using the titanium oxide fine particles (1A) as the first titanium oxide fine particles. The dispersion particle diameters were measured by a dynamic light scattering method using a laser light (ELSZ-2000ZS by Otsuka Electronics Co., Ltd.).

TABLE 3

| | | Titanium oxide fine | | | Evaluation result | | | |
|---|---|---|---|---|---|---|---|---|
| | | partide dispersion liquid | | | | | Time taken to | Concentration |
| | Evaluation | | | Mixing | D₅₀ | D₉₀ | be decomposed | after 24 h |
| | sample | Type | | ratio | (nm) | (nm) | to 1 ppm (h) | (ppm) |
| Working example 1 | E-1 | 1A | 2A | 80:20 | 10 | 15 | 2.0 | — |
| Working example 2 | E-2 | 1A | 2A | 60:40 | 12 | 29 | 3.9 | — |
| Working example 5 | E-5 | 1A | 2B | 80:20 | 12 | 18 | 2.4 | — |
| Working example 8 | E-8 | 1A | 2C | 90:10 | 9 | 14 | 3.5 | — |
| Working example 9 | E-9 | 1A | 2A | 80:20 | 11 | 17 | 3.5 | — |
| Comparative example 1 | C-1 | 1A | 3A | 80:20 | 13 | 20 | 9.0 | — |
| Comparative example 2 | C-2 | 1A | 3B | 80:20 | 13 | 18 | — | 2.8 |
| Comparative example 3 | C-3 | 1A | — | 100:0 | 8 | 13 | — | 3.8 |
| Comparative example 4 | C-4 | — | 2A | 0:100 | 20 | 25 | — | 5.0 |
| Comparative example 5 | C-5 | 1A | 3C | 80:20 | 14 | 20 | 14.0 | — |
| Comparative example 6 | C-6 | 1A | 3D | 80:20 | Agglutinated, | | — | — |
| | | | | | Precipitated | | | |
| Comparative example 7 | C-7 | 1A | 1I | 80:20 | 11 | 16 | — | 4.0 |
| Comparative example 8 | C-8 | 1A | — | 100:0 | 12 | 20 | — | 4.8 |

As compared to the case (comparative example 1) where the titanium oxide fine particles with only iron solid-dissolved therein were mixed with the titanium oxide fine particles (1A) with tin and molybdenum solid-dissolved therein; the case (comparative example 2) where the titanium oxide fine particles with only silicon solid-dissolved therein were mixed with the titanium oxide fine particles (1A); or the case (comparative example 7) where the titanium oxide fine particles with no metal component solid-dissolved therein were mixed with the titanium oxide fine particles (1A), the case (working example 1) where the titanium oxide fine particles with iron and silicon solid-dissolved therein were mixed with the titanium oxide fine particles (1A) exhibited a favorable acetaldehyde decomposition capability under visible light irradiation i.e. it was confirmed that the titanium oxide fine particle mixture of the present invention was superior as a photocatalyst under a visible light.

As can be seen from the results of the working example 9 and comparative example 8, it was confirmed that even in the case of a binder-containing photocatalyst thin film, by mixing the titanium oxide fine particles (2A) with the iron component and silicon component solid-dissolved therein with the titanium oxide fine particles (1A), the photocatalytic activity under visible light irradiation had been enhanced significantly as compared to when the titanium oxide fine particles (1A) were used alone.

As can be seen from the results of the comparative examples 3 and 4, an insufficient photocatalytic activity was observed under visible light irradiation when the first titanium oxide fine particles or the second titanium oxide fine particles were used alone.

As can be seen from the result of the comparative example 5, as for the silicon component contained in the second titanium oxide fine particles, by merely having such silicon component supported on the surfaces of the titanium oxide fine particles, there could only be observed an insufficient photocatalytic activity under visible light irradiation as compared to the titanium oxide fine particle mixture of the present invention.

Further, as can be seen from the result of the comparative example 6, when the iron component is not solid-dissolved in the titanium oxide fine particles, the iron component will cause the titanium oxide fine particles in the dispersion liquid to agglutinate and precipitate, which may then turn the photocatalyst film obtained opaque.

In this way, a superior photocatalytic capability was confirmed with the titanium oxide fine particle mixture of the present invention that contains the titanium oxide fine particles with the two iron and silicon components solid-dissolved therein.

Moreover, shown collectively in Table 4 are the mixing ratios, dispersion particle diameters (D₅₀, D₉₀) and acetaldehyde gas decomposition test results of the titanium oxide fine particle dispersion liquids, when using various titanium oxide fine particles as the first titanium oxide fine particles.

TABLE 4

| | | Titanium oxide fine | | | Evaluation result | | | |
|---|---|---|---|---|---|---|---|---|
| | | particle dispersion liquid | | | | | Time taken to | Concentration |
| | Evaluation | | | Mixing | D₅₀ | D₉₀ | be decomposed | after 24 h |
| | sample | Type | | ratio | (nm) | (nm) | to 1 ppm (h) | (ppm) |
| Working example 3 | E-3 | 1B | 2A | 80:20 | 11 | 18 | 3.2 | — |
| Comparative example 9 | C-9 | 1B | — | 100:0 | 7 | 12 | — | 4.5 |
| Working example 4 | E-4 | 1C | 2A | 80:20 | 15 | 21 | 4.3 | — |
| Comparative example 10 | C-10 | 1C | — | 100:0 | 14 | 20 | — | 4.6 |
| Working example 6 | E-6 | 1D | 2A | 70:30 | 13 | 20 | 3.4 | — |
| Comparative example 11 | C-11 | 1D | — | 100:0 | 9 | 15 | — | 4.6 |
| Working example 7 | E-7 | 1E | 2A | 60:40 | 18 | 26 | 5.8 | — |
| Comparative example 12 | C-12 | 1E | — | 100:0 | 16 | 26 | — | 4.7 |
| Working example 10 | E-10 | 1F | 2A | 80:20 | 10 | 14 | — | 1.8 |
| Comparative example 13 | C-13 | 1F | — | 100:0 | 9 | 13 | — | 5.0 |
| Working example 11 | E-11 | 1J | 2A | 80:20 | 11 | 17 | — | 1.5 |

As shown in Table 4, a favorable acetaldehyde decomposition capability was observed with a photocatalyst thin film produced from the dispersion liquid of the titanium oxide fine particle mixture of the first titanium oxide fine particles with the tin component and the visible light responsiveness-enhancing transition metal component (molybdenum, tungsten or vanadium component) solid-dissolved therein; and the second titanium oxide fine particles with the iron component and the silicon component solid-dissolved therein, even with a small amount of the photocatalyst and under an irradiation by LED which only emits visible lights.

### INDUSTRIAL APPLICABILITY

The titanium oxide fine particle dispersion liquid of the present invention is useful for forming a photocatalyst thin film on various base materials including inorganic substances such as glass and metals; and organic substances such as a polymer film (e.g. PET film), when applied thereto. The titanium oxide fine particle dispersion liquid of the present invention is especially useful for forming a transparent photocatalyst thin film on a polymer film.

1. A titanium oxide fine particle mixture comprising:
first titanium oxide fine particles; and
second titanium oxide fine particles, wherein
the second titanium oxide fine particles are titanium oxide fine particles with at least an iron component and a silicon component solid-dissolved therein, and
the first titanium oxide fine particles are titanium oxide fine particles that may have a component(s) other than an iron component and a silicon component solid-dissolved therein.

2. The titanium oxide fine particle mixture according to claim 1, wherein a mixing ratio between the first titanium oxide fine particles and the second titanium oxide fine particles is 99 to 0.01 in terms of a mass ratio [(first titanium oxide fine particles)/(second titanium oxide fine particles)].

3. The titanium oxide fine particle mixture according to claim 1, wherein the first titanium oxide fine particles are titanium oxide fine particles with a tin component and a visible light responsiveness-enhancing transition metal component solid-dissolved therein.

4. The titanium oxide fine particle mixture according to claim 3, wherein the tin component is contained and solid-dissolved in the first titanium oxide fine particles by an amount of 1 to 1,000 in terms of a molar ratio to titanium (Ti/Sn).

5. The titanium oxide fine particle mixture according to claim 3, wherein the transition metal component solid-dissolved in the first titanium oxide fine particles is at least one selected from vanadium, chromium, manganese, niobium, molybdenum, rhodium, tungsten and cerium.

6. The titanium oxide fine particle mixture according to claim 5, wherein the transition metal component solid-dissolved in the first titanium oxide fine particles is at least one selected from molybdenum, tungsten and vanadium.

7. The titanium oxide fine particle mixture according to claim 6, wherein the molybdenum, tungsten and vanadium components are each contained and solid-dissolved in the first titanium oxide fine particles by an amount of 1 to 10,000 in terms of a molar ratio to titanium (Ti/Mo, Ti/W or Ti/V).

8. The titanium oxide fine particle mixture according to claim 1, wherein the iron and silicon components are each contained and solid-dissolved in the second titanium oxide fine particles by an amount of 1 to 1,000 in terms of a molar ratio to titanium (Ti/Fe or Ti/Si).

9. The titanium oxide fine particle mixture according to claim 1, wherein the second titanium oxide fine particles further have at least one component selected from molybdenum, tungsten and vanadium solid-dissolved therein.

10. A titanium oxide fine particle dispersion liquid wherein the titanium oxide fine particle mixture according to claim 1 is dispersed in an aqueous dispersion medium.

11. The titanium oxide fine particle dispersion liquid according to claim 10, wherein the titanium oxide fine particle dispersion liquid further comprises a binder.

12. The titanium oxide fine particle dispersion liquid according to claim 11, wherein the binder is a silicon compound-based binder.

13. A photocatalyst thin film comprising the titanium oxide fine particle mixture according to claim 1.

14. The photocatalyst thin film according to claim 13, wherein the photocatalyst thin film further comprises a binder.

15. A member wherein the photocatalyst thin film according to claim 13 is formed on a surface of a base material.

16. A method for producing a titanium oxide fine particle dispersion liquid, comprising:
(1) a step of producing a tin component and transition metal component-containing peroxotitanic acid solution from a raw material titanium compound, tin compound, transition metal compound, basic substance, hydrogen peroxide and aqueous dispersion medium;
(2) a step of obtaining a tin component and transition metal component-containing titanium oxide fine particle dispersion liquid by heating the tin component and transition metal component-containing peroxotitanic acid solution produced in the step (1) at 80 to 250° C. under a controlled pressure;
(3) a step of producing an iron component and silicon component-containing peroxotitanic acid solution from a raw material titanium compound, iron compound, silicon compound, basic substance, hydrogen peroxide and aqueous dispersion medium;
(4) a step of obtaining an iron component and silicon component-containing titanium oxide fine particle dispersion liquid by heating the iron component and silicon component-containing peroxotitanic acid solution produced in the step (3) at 80 to 250° C. under a controlled pressure; and
(5) a step of mixing the two kinds of titanium oxide fine particle dispersion liquids produced in the steps (2) and (4).
